(19) United States
(12) Patent Application Publication
(10) Pub. No.: US 2026/0189523 A1
(43) Pub. Date: Jul. 2, 2026

(54) Prompt-Based Proactive Conversation Support

(71) Applicant: Samsung Electronics Co., Ltd., Suwon-si, Gyeonggi-do (KR)

(72) Inventors: Ji-Hyeok YOON, San Jose, CA (US); Moo Chan SONG, Foster City, CA (US); Priti JAIN, Sunnyvale, CA (US)

(21) Appl. No.: 19/267,398

(22) Filed: Jul. 11, 2025

Related U.S. Application Data
(60) Provisional application No. 63/712,243, filed on Oct. 25, 2024.

(51) Int. Cl. H04L 51/02; H04L 51/04; H04L 51/216

(52) U.S. Cl. CPC H04L 51/02; H04L 51/04; H04L 51/216

(57) ABSTRACT

A method includes receiving a conversation history from a messaging interface, extracting relationship information involving one or more users based on the conversation history, generating, using a first large language model (LLM), a personalized prompt based on the relationship information. To generate the personalized prompt, the method includes predicting user interactions based on real-time chat context and historical interaction patterns using a dynamic pre-fetching model. The method further includes generating, using a second LLM, an initial reply suggestion based on the personalized prompt. Generating the initial reply suggestion includes asynchronously transmitting partial pre-processed data from the first LLM to the second LLM using a streaming interface and generating the initial reply suggestion using a lightweight language model (LM) of a latency-aware fallback model in response to detecting of a processing delay of the second LLM.

### CROSS-REFERENCE TO RELATED APPLICATIONS AND CLAIM OF PRIORITY

The present application claims priority to U.S. Provisional Patent Application No. 63/712,243, filed on Oct. 25, 2024. The contents of the above-identified patent documents are incorporated herein by reference.

### TECHNICAL FIELD

This disclosure relates generally to messaging systems and processes. More specifically, this disclosure relates to prompt-based proactive conversation support.

### BACKGROUND

With the rapid development of chatbot technology and the increasing use of social media, the volume of text-based communication has been growing exponentially. However, as conversation volumes increase, users are faced with frequent mistakes in conversation such as errors in understanding context, use of inappropriate words, and typos, leading to unintended message transmission. Further, chatbots may lack specialized knowledge, making it difficult to maintain a smooth conversation while including insufficient personalization, leading to one-size-fits-all conversation support without considering individual situations and characteristics. Recently, the use of large-scale language models (LLMs) in chatbots based on smart reply and summarization features have been introduced.

### SUMMARY

The present disclosure relates generally to prompt-based proactive conversation support.

In one embodiment, a method is provided. The method includes receiving a conversation history from a messaging interface, extracting relationship information involving one or more users based on the conversation history, generating, using a first large language model (LLM), a personalized prompt based on the relationship information. To generate the personalized prompt, the method includes predicting user interactions based on real-time chat context and historical interaction patterns using a dynamic pre-fetching model. The method further includes generating, using a second LLM, an initial reply suggestion based on the personalized prompt. Generating the initial reply suggestion includes asynchronously transmitting partial pre-processed data from the first LLM to the second LLM using a streaming interface and generating the initial reply suggestion using a lightweight language model (LM) of a latency-aware fallback model in response to detecting of a processing delay of the second LLM.

In another embodiment, an electronic device is provided. The electronic device includes at least one processing device configured to cause the electronic device to receive a conversation history from a messaging interface, extract relationship information involving one or more users based on the conversation history, generate, using a first large language model (LLM), a personalized prompt based on the relationship information. To generate the personalized prompt, the at least one processing device is configured to cause the electronic device to predict user interactions based on real-time chat context and historical interaction patterns using a dynamic pre-fetching model. The at least one processing device is also configured to cause the electronic device to generate, using a second LLM, an initial reply suggestion based on the personalized prompt. To generate the initial reply suggestion, the at least one processing device is configured to cause the electronic device to asynchronously transmit partial pre-processed data from the first LLM to the second LLM using a streaming interface and generate the initial reply suggestion using a lightweight language model (LM) of a latency-aware fallback model in response to detecting of a processing delay of the second LLM.

In yet another embodiment, a non-transitory computer-readable medium is provided. The non-transitory computer-readable medium includes program code, that when executed by at least one processor of an electronic device, causes the electronic device to receive a conversation history from a messaging interface, extract relationship information involving one or more users based on the conversation history, generate, using a first large language model (LLM), a personalized prompt based on the relationship information. To generate the personalized prompt, the program code, that when executed by at least one processor of an electronic device, causes the electronic device to predict user interactions based on real-time chat context and historical interaction patterns using a dynamic pre-fetching model. The program code, that when executed by at least one processor of an electronic device, causes the electronic device to generate, using a second LLM, an initial reply suggestion based on the personalized prompt. To generate the initial reply suggestion, the program code, that when executed by at least one processor of an electronic device, causes the electronic device to asynchronously transmit partial pre-processed data from the first LLM to the second LLM using a streaming interface and generate the initial reply suggestion using a lightweight language model (LM) of a latency-aware fallback model in response to detecting of a processing delay of the second LLM.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example network configuration including an electronic device according to an embodiment of the present disclosure;

FIG. 2 illustrates an example system according to an embodiment of the present disclosure;

FIGS. 3A and 3B illustrate block diagrams of example device architectures to support prompt-based proactive conversation support systems according to an embodiment of the present disclosure;

FIG. 4 illustrates a block diagram of an example prompt-based proactive conversation support system architecture according to an embodiment of the present disclosure;

FIG. 5 illustrates a block diagram of an example flow chart of a prompt-based proactive conversation support algorithm according to an embodiment of the present disclosure;

FIG. 6 illustrates a block diagram of an example error detection function of a prompt-based proactive conversation support system according to an embodiment of the present disclosure;

FIGS. 7A and 7B illustrate block diagrams of example pre-emptive dialogue function of a prompt-based proactive conversation support system according to an embodiment of the present disclosure;

FIG. 8 illustrates a block diagram of an example pre-transmission verification function of a prompt-based proactive conversation support system according to an embodiment of the present disclosure;

FIGS. 9A and 9B illustrate a block diagram of an example speed optimization function for pre-transmission verification of a prompt-based proactive conversation support system according to an embodiment of the present disclosure; and

FIG. 10 illustrates an example method for a prompt-based proactive conversation support according to an embodiment of the present disclosure.

### DETAILED DESCRIPTION

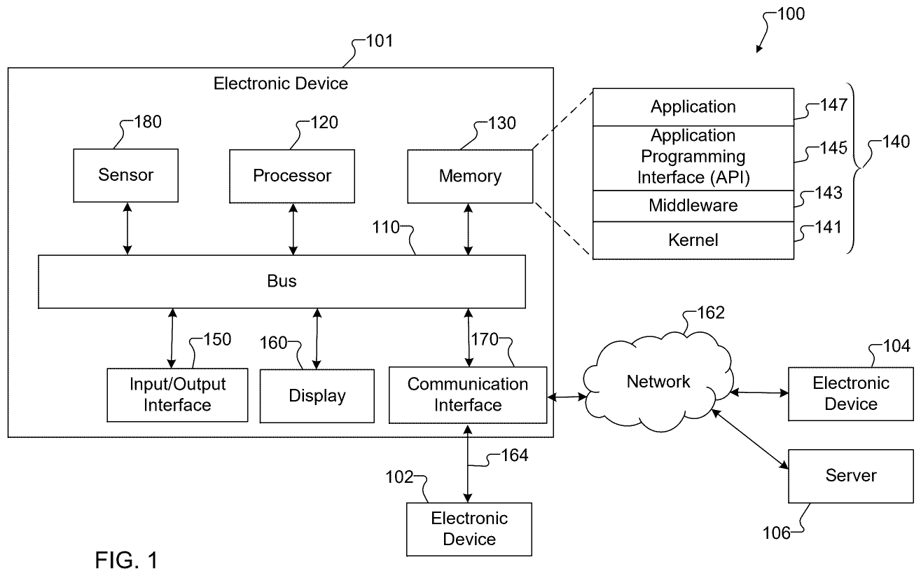

FIG. 1 through FIG. 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, with the rapid development of chatbot technology and the increasing use of social media, the volume of text-based communication has been growing exponentially. However, as conversation volumes increase, users are faced with frequent mistakes in conversation such as errors in understanding context, use of inappropriate words, and typos, leading to unintended message transmission. Further, chatbots may lack specialized knowledge, making it difficult to maintain a smooth conversation while including insufficient personalization, leading to one-size-fits-all conversation support without considering individual situations and characteristics. Recently, the use of large-scale language models (LLMs) in chatbots based on smart reply and summarization features have been introduced.

However, these chatbots have limitations in accurately understanding user intentions and preventing errors. Additionally, existing profanity filters lack personalization and apply uniformly to each user, rendering them ineffective. In particular, in a massive conversation volume, users can lose track of context or misunderstand it, leading to inappropriate responses. Further, the chatbots may use words or expressions that are not suitable for a specific audience can unintentionally cause discomfort to others. When specialized knowledge is required for a conversation, these chatbots often lack information that makes smooth communication difficult. Additionally, when transmitting media, unwanted personal information exposure or transmission of inappropriate photos may lead to an awkward situation. Further, these chatbots face difficulty in remembering response time as the message response times may vary from user to user.

The present disclosure provides for systems and methods for a prompt-based proactive conversation support system that overcome these challenges. In particular, the present disclosure provides a system that provides early conversation support based on personalized prompts for users. The present disclosure provides systems and methods that incorporate multiple LLMs to pre-process and generate response actions, such as pre-emptive messages, as well as provide verification functions.

The methods and systems of the present disclosure leverage language models by analyzing message data stored on a user device to generates customized prompts tailored to each individual, enabling context understanding, language misuse prevention, provision of specialized knowledge, photo transmission prevention, and message transmission time recommendation features.

FIG. 1 illustrates an example network configuration 100 including an electronic device according to an embodiment of the present disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to prompt-based proactive conversation support.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to prompt-based proactive conversation support. These functions can be performed by a single application or by multiple applications that each conduct one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second external electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the second external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to prompt-based proactive conversation support.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

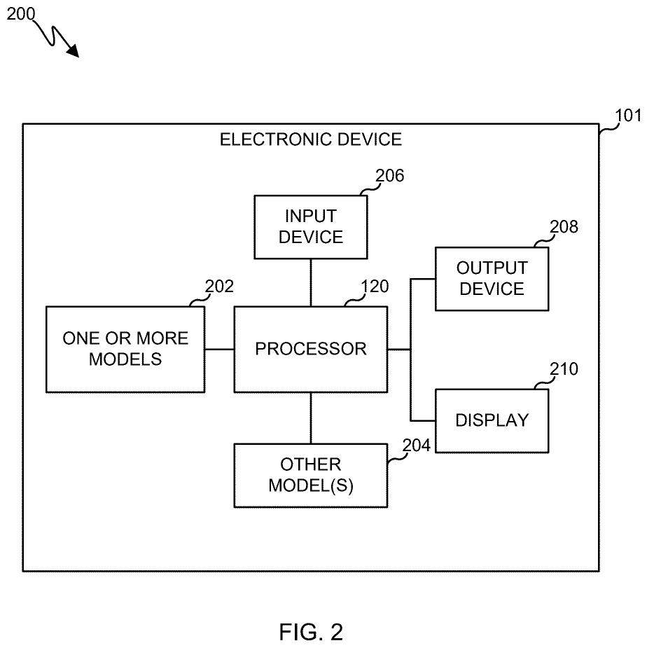

FIG. 2 illustrates an example system 200 according to an embodiment of the present disclosure. For ease of explanation, the system 200 is described as involving the use of the electronic device 101 in the network configuration 100 of FIG. 1. However, the system 200 may be used with any other suitable device (such as the server 106) or a combination of devices (such as the electronic device 101 and the server 106) and in any other suitable system(s).

As shown in FIG. 2, the system 200 includes the electronic device 101, which includes the processor 120. The processor 120 is operatively coupled to or otherwise configured to use one or more machine learning models, such as a one or more conversation support models 202. As further described in this disclosure, the one or more conversation support models 202 can include various components and sub-models, such as multiple large language models (LLMs). The one or more conversation support models 202 can receive an input, and the one or more conversation support models 202 can operate to perform prompt-based proactive conversation support depending on the context or application. The one or more conversation support models 202 can generate an output used to perform an action by the electronic device 101 requested in the input.

The processor 120 can also be operatively coupled to or otherwise configured to use one or more other machine learning models 204, such as other models related to automated speech recognition or voice assistant processes. It will be understood that the machine learning models 204 can be stored in a memory of the electronic device 101 (such as the memory 130) and accessed by the processor 120 to perform automated speech recognition tasks, spoken language understanding tasks, and/or other tasks. However, the machine learning models 204 can be stored in any other suitable manner.

The system 200 also includes an input device 206 (such as a keyboard or microphone), an output device 208 (such as a speaker or headphones), and a display 210 (such as a screen or a monitor like the display 160). The processor 120 receives an input from the input device 206 and provides the input to the one or more conversation support models 202. The one or more conversation support models 202 processes the input and outputs a result to the processor 120. The processor 120 may instruct one or more further actions that correspond to one or more instructions or requests provided in the utterance.

Although FIG. 2 illustrates one example of a system 200, various changes may be made to FIG. 2. For example, in some embodiments, the input device 206, the output device 208, and the display 210 can be connected to the processor 120 within the electronic device 101, such as via wired connections or circuitry. In other embodiments, the input device 206, the output device 208, and the display 210 can be external to the electronic device 101 and connected via wired or wireless connections. Also, in some cases, the one or more conversation support models 202 and one or more of the other machine learning models 204 can be stored as separate models called upon by the processor 120 to perform certain tasks or can be included in and form a part of one or more larger machine learning models. Further, in some embodiments, one or more of the models, such as the one or more conversation support models 202 or one or more of the other machine learning models 204, can be stored remotely from the electronic device 101, such as on the server 106. Here, the electronic device 101 can transmit requests including inputs to the server 106 for processing of the inputs using the machine learning models, and the results can be sent back to the electronic device 101. In addition, in some embodiments, the electronic device 101 can be replaced by the server 106, which receives audio inputs from a client device and transmits instructions back to the client device to execute functions associated with instructions included in utterances.

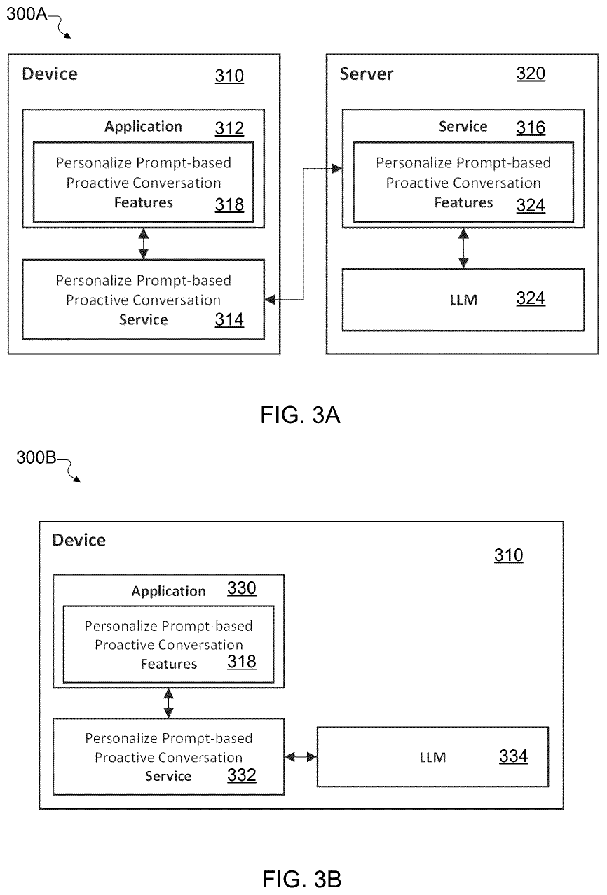

FIGS. 3A and 3B illustrate block diagrams of example device architectures 300A, 300B to support prompt-based proactive conversation support systems according to an embodiment of the present disclosure. In particular, the device architectures 300A, 300B may be used by the processor 120 of the electronic device 101 of FIG. 1 to perform prompt-based proactive conversation support functions, e.g., in response to a query by a user or in operations by other applications.

As shown in FIG. 3A, the device architecture 300A includes a user device 310 having a processor configured to support an application 312 as part of a prompt-based conversation assistant system 314. The prompt-based conversation assistant system 314 includes a service portion 316 that is stored in a remote server 320 and configured to perform response action generation. The application 312 may include first conversation assistant features 318 that are provided to the prompt-based conversation assistant system 314 to allow the prompt-based conversation assistant system 314 to generate response actions. The user device 310 is communicatively coupled to the remote server 320 that includes a processor configured to support second conversation assistant features 322 derived from one or more LLM models 324. The second conversation assistant features 322 are provided to the prompt-based conversation assistant system 314 of the user device 310 as additional input to generate response actions.

Alternatively, the prompt-based conversation assistant system may be deployed fully on the device. As shown in FIG. 3B, the user device 310 includes an application 330 as part of a prompt-based conversation assistant system 332. The application 330 may store the service portion 316 and provide them to the prompt-based conversation assistant system 332 for generation. Additionally, the prompt-based conversation assistant system 332 is communicatively coupled to one or more LLM models 334.

The service portion 316 is responsible for handling requests from the, which may take a relatively long time to process. On the other hand, the application 312 requires implementation in the service that uses the device architecture 300A.

The user device 310 being referred to is typically a mobile device, but it may be applied to various other devices as well. The distinction between the device architecture 300A and the device architecture 300B depends on the location of the one or more LLMs, with server-based one or more LLM models 324 using client-server architecture and on device-based one or more LLM models 334 having all features deployed within the user device 310 itself.

In other words, if the one or more LLM models 324 is running on a server, then a client-server architecture can be used to communicate between the client and server. However, if the one or more LLM models 334 is running on-device (such as within the user device 310 or other device), then all features are implemented directly within the user device 310, without the need for client-server communication.

Although FIGS. 3A and 3B illustrate block diagrams of example device architectures 300A, 300B to support prompt-based proactive conversation support systems according to an embodiment of the present disclosure, various changes may be made to FIGS. 3A and 3B. For example, various components and functions in FIGS. 3A and 3B may be combined, further subdivided, replicated, or rearranged according to particular needs. Also, one or more additional components and functions may be included if needed or desired.

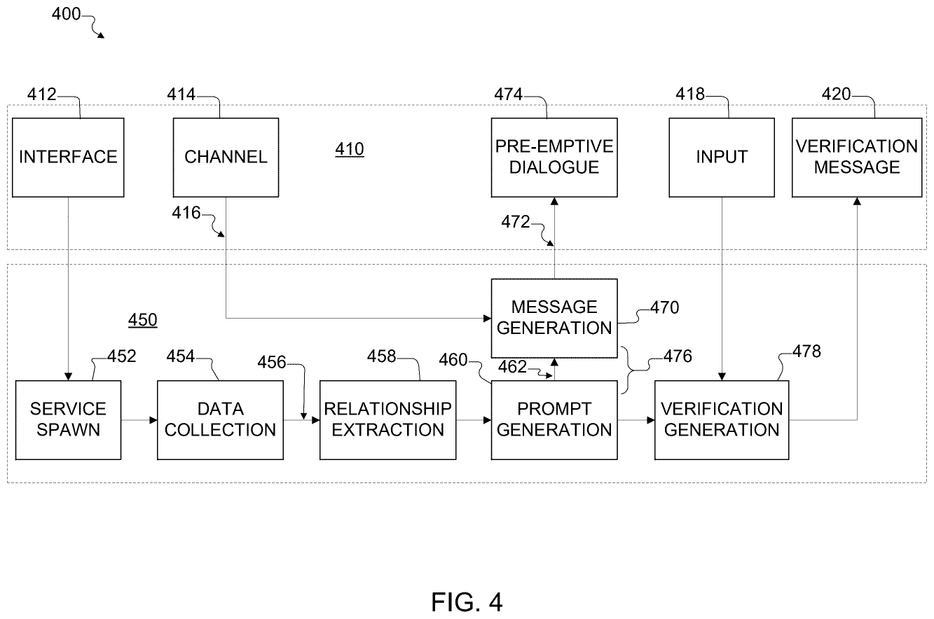

FIG. 4 illustrates a block diagram of an example prompt-based proactive conversation support system architecture 400 according to an embodiment of the present disclosure. In particular, the system architecture 400 may be used by the processor 120 of the electronic device 101 of FIG. 1 to perform prompt-based proactive conversation support functions, e.g., in response to a query by a user or in operations by other applications.

As shown in FIG. 4, the prompt-based proactive conversation support system architecture 400 includes a foreground portion 410 and a background portion 450. The foreground portion 410 includes a messaging interface 412, and a conversation channel 414 that produces a conversation history 416. The background portion 450 includes a service spawn 452 that activates upon instructions from the messaging interface 412. The service spawn 452 may then activate data collection 454 that collects conversation data 456 from a user (either directly or indirectly). The data collection 454 then provides the conversation data 456 for relationship extraction to generate relationship information 458. The relationship information 458 is then used in a first LLM 460 to generate a personalized prompt 462. The first LLM 460 may be configured for anticipatory pre-processing. For example, the first LLM 460 may operate as a frontline processor of incoming chat data. The first LLM 460 is configured to predictively pre-process textual messages, images, and videos using a context-aware anticipation model, which evaluates recent conversation activity, user habits, and engagement signals to determine what content is likely to be relevant next. The first LLM 460 may also segment and structure multimodal data into hierarchical representations, which may include textual tokens with semantic tags, image content with object annotations or OCR results, and video metadata including scene boundaries or timestamped captions. These representations are optimized for progressive transmission, meaning that initial coarse-level data can be sent first, with fine-grained enhancements streamed later.

Additionally, the first LLM 460 may include a dynamic pre-fetching function. The dynamic prefetching engine or function that initiates preprocessing in advance of user interaction. The dynamic pre-fetching function is responsible for anticipating user actions and proactively pre-processing relevant chat data before explicit user input is received. The dynamic prefetching function operates using behavioral modeling, historical interaction data, and context-aware predictions to ensure real-time response suggestion. For behavioral analysis, the dynamic prefetching function records chat interactions and predicts likely next responses using machine learning models, including reinforcement learning. For adaptive pre-processing, relevant chat messages, images, and video metadata are selected, transformed, and structured before explicit replies are needed. For dynamic priority updating, pre-fetching priorities are adjusted in real-time to balance response accuracy and efficiency. The dynamic prefetching function includes a behavioral prediction model trained on real-time and historical chat activity. This behavioral prediction model evaluates user typing patterns, conversation flow and tone, and prior selections and re-engagement patterns. The dynamic prefetching function may use a reinforcement learning (RL) function that continuously adjusts which data should be preprocessed next, balancing anticipated relevance of data, model confidence, and available computing and bandwidth resources. The RL model refines its policy through reward signals based on response acceptance, latency, and user interaction with the suggestion user interface. The dynamic pre-fetching function ensures the system remains efficient, even in high-volume or latency-sensitive environments.

The personalized prompt 462 is input into a second LLM 470 that uses the personalized prompt 462 as well as the conversation history 416 to generate a response actions 472, such as a pre-emptive dialogue 474 that is provided to the foreground portion 410. A streaming interface 476 connects the first LLM 460 and the second LLM 470. The streaming interface 476 allows for asynchronous model coordination. In particular, the streaming interface allows tight synchronization between model components. The interface transmits partially pre-processed data from the first LLM 460 to the second LLM 470 in an asynchronous, event-driven fashion. The streaming interface 476 includes a synchronization mechanism that manages the arrival order, versioning, and coherence of streamed data segments. The streaming interface 476 enables progressive suggestion rendering, where the second LLM 470 may emit a draft reply, then incrementally refine it as more upstream data is received. This approach addresses a core challenge of multimodal LLMs coordinating times while maintaining semantic integrity in generated outputs. different latencies and processing.

The second LLM 470 may be configured for progressive action suggestion generation. For example, the second LLM 470 may be designed for real-time generation of response actions, adapting as new information becomes available. For example, the second LLM 470 may be configured to accept partial, progressively streamed inputs from the first LLM and begin generating suggestions immediately, even if the full context is not yet received. The second LLM 470 may also maintain dynamic adaptation, updating the content or structure of a response suggestion on the fly as more of the chat context or multimodal metadata arrives. Additionally, the second LLM 470 may support interruptible decoding, allowing draft replies to be refined, extended, or replaced based on updated upstream data. The second LLM 470 allows users to view responsive draft suggestions that feel immediate, even as additional context is still being processed.

A user may then provide additional input 418 using the messaging interface 412 for verification message generation 478, which includes the personalized prompt 462. The verification message generation 478 may use the second LLM 470 to generate a verification message 420. The pre-emptive dialogue 474 and the verification message 420 are the key dialogue pairs suggested by the prompt-based proactive conversation support system architecture 400, and all background processes must be performed for these processes to proceed successfully. LLM inputs data in text format as default, but may also allow multiple sources (image, video, document, audio) depending on the case. The output data is in text format.

Additionally, or alternatively, the prompt-based proactive conversation support system architecture 400 may include a latency-aware fallback model configured for seamless response continuity. To address the inevitability of occasional processing delays, the prompt-based proactive conversation support system architecture 400 includes a latency-aware fallback model that ensures user-facing responsiveness. The latency-aware fallback model uses a lightweight predictive model (e.g., distilled transformer or intent classifier) to generate a provisional placeholder reply within a strict latency budget (e.g., under 100 ms). As the full LLM-generated suggestion becomes available, the fallback model refines the placeholder reply, using token alignment. semantic similarity metrics and attention-weighted fusion. The latency-aware fallback model includes a semantic blending mechanism that ensures smooth transition between the placeholder and the high-fidelity LLM output, avoiding excessive changes in tone or meaning. This ensures the prompt-based proactive conversation support system architecture 400 can provide fluid conversational user experience, even under variable latency conditions.

The prompt-based proactive conversation support system architecture 400 can be divided into foreground and background processing, and the background portion 450 may vary depending on the application or system structure being used, but for user experience, the prompt-based proactive conversation support system architecture 400 suggests to pre-process conversation data collection 454 and personalized prompt generation using the first LLM 460 in the background. Each of the first LLM 460 and the second LLM 470 may be implemented as cloud-based LLMs, as on-device LLMs, or a combination thereof.

The prompt-based proactive conversation support system architecture 400 provides early conversation support based on personalized prompts for users. By analyzing message data stored on the user device 310, the prompt-based proactive conversation support system architecture 400 generates customized prompts tailored to each individual, enabling context understanding, language misuse prevention, provision of specialized knowledge, photo transmission prevention, and message transmission time recommendation features.

Although FIG. 4 illustrates a block diagram of an example prompt-based proactive conversation support system architecture 400, various changes may be made to FIG. 4. For example, various components and functions in FIG. 4 may be combined, further subdivided, replicated, or rearranged according to particular needs. Also, one or more additional components and functions may be included if needed or desired.

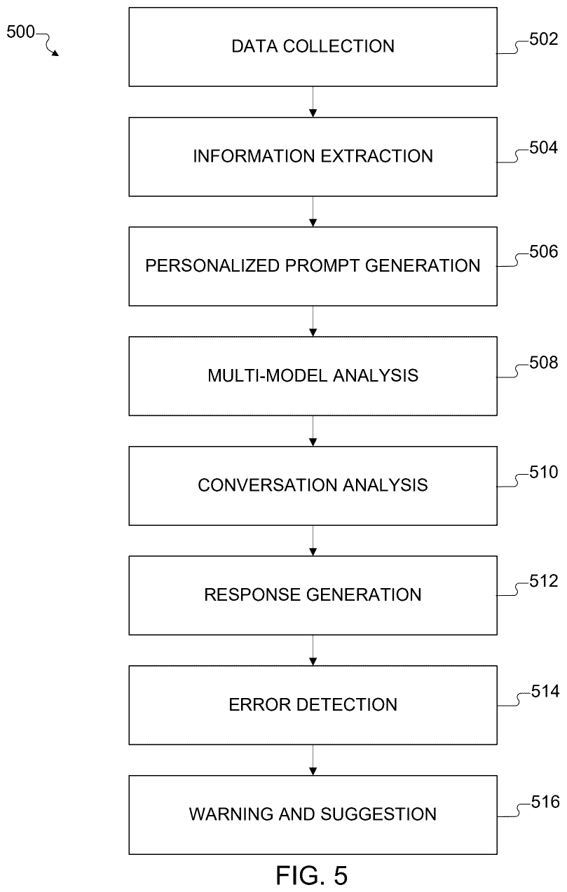

FIG. 5 illustrates a block diagram of an example flow chart of a prompt-based proactive conversation support algorithm 500 according to an embodiment of the present disclosure.

As shown in FIG. 5, the prompt-based proactive conversation support algorithm 500 includes information extraction 502, prompt generation 504, multi-modal analysis 506, conversation analysis 508, followed by response action generation 510 and error detection 512. Additionally, the prompt-based proactive conversation support algorithm 500 may also include warning and suggestion 514 and 516.

The prompt-based proactive conversation support algorithm 500 includes a series of functions to be performed, such as by a processor of an electronic device, to analyze user-generated content, detect potential issues, and generate personalized responses. In information extraction 502, user input is collected. During prompt generation 504, relevant data points such as title, relationship, and taboo words are identified. In multi-modal analysis 506, an LLM (such as the first LLM 460) generates tailored prompts based on extracted information. During the response action generation 510, real-time conversation content is analyzed to understand context. In error detection 512, personalized prompts, contextual information, and a knowledge database are used to generate expected responses and related information. In warning and suggestion 514, inappropriate language use, information errors, and personal data exposure through input messages and intended images is detected. In 516, warning messages are displayed to users when errors are detected and provide alternative responses and suggestion updates. Additionally, the prompt-based proactive conversation support algorithm 500 includes the use of conversation analysis 508 to analyze multimedia data such as images and videos to determine whether personal information is exposed or if the content contains inappropriate material.

The information extraction 502 is responsible for acquiring as much information as possible from user devices to enhance the predictive accuracy of the system. The information extraction 502 is set as the default operation in the background and continuously monitors user data for changes at a fixed time interval. If any changes are detected, it collects the new data and proceeds to the next sequence. The information extraction 502 collects various types of data, including contact profile information, such as user profile information stored on the device, such as contact lists and associated metadata, account information such as account details used by the service or application that leverages the system, including account names, nationality, date of birth, location information, user activity records, and user activity records from services or applications with access permissions, including chat history, comment history, and received message history.

Additionally, this function collects data to provide more personalized insights, such as active hours, including the times of day when the user is most active, and location information, such as location information to understand the user's geographic context. By collecting these diverse types of data, the information extraction 502 helps to improve the predictive accuracy of the system and enables more personalized recommendations.

The prompt generation 504 is responsible for extracting personalization-related data from the data collected by the information extraction 502. This function aims to uncover insights that will enable personalized interactions. This information extraction stage is important in developing personalized profiles. To achieve better performance, a high-performance server-side LLM may be used for this process. On the other hand, considering the handling of personal and sensitive user data, as well as other individuals'personal information, alternative machine learning algorithms or utilizing on-device LLMs. This can improve the balance between computational efficiency and privacy protection.

The multi-modal analysis 506 is designed to create tailored prompts based on user-specific data. This function utilizes the insights gained from the prompt generation 504 to craft personalized prompts that cater to individual preferences.

The multi-modal analysis 506 serves as a bridge between the prompt generation 504 and the LLM. It leverages the extracted information to generate prompts that are both informative and engaging. The multi-modal analysis 506 may operate in two primary modes; rule-based output and LLM-driven prompt generation.

In the rule-based output mode, the function retrieves relevant data from the database using predefined rules. This data is then outputted in a straightforward manner, without any additional processing or manipulation.

For more complex prompt generation, the multi-modal analysis 506 employs an LLM to create a chain of thought-based prompts. This process involves feeding the extracted information into the LLM and allowing it to generate context-specific responses. The resulting prompts are thus both informed by the user's preferences and crafted with the nuances that come from AI-driven reasoning.

The multi-modal analysis 506 offers a robust solution for generating tailored prompts that meet individual user needs. Its adaptability to both rule-based output and LLM-driven prompt generation makes it useful for various applications, from product recommendation systems to content creation platforms.

In the context of the overall system architecture, the multi-modal analysis 506 plays a critical role in delivering personalized experiences to users. By creating prompts that are informed by user-specific data and crafted with AI-driven reasoning, this function contributes significantly to the overall efficacy and engagement of the system.

The multi-modal analysis 506 can operate in both rule-based output and LLM-driven prompt generation modes, making it suitable for various applications. The multi-modal analysis 506 generates prompts based on individual user preferences and conversation history. The multi-modal analysis 506 may direct retrieval of relevant data from the database using predefined rules and use an LLM to create a chain of thought-based prompts that cater to specific contexts and nuances.

The conversation analysis 508 is designed to analyze various types of attached files by combining multiple models. This function aims to provide accurate content analysis for diverse file formats.

The conversation analysis 508 may operate in two modes; separate function utilization and multi-source LLM. For commonly used file formats, the separate function utilization mode utilizes dedicated functions specifically designed for each attached file type. These functions can convert the contents into text format more efficiently. For complex file types like images, videos, or audio files that require deeper analysis, this mode employs a multi-source LLM that analyzes the attached file content in various aspects, including its tone, content, and visual representation.

To provide a rapid real-time callback to users, the prompt-based proactive conversation support algorithm 500 assigns analysis priority orders to incoming messages. However, using general natural language understanding techniques would require high computational resources, making it unsuitable for assigning priorities. Therefore, the conversation analysis 508 employs linguistic analysis to regulate priority orders while enabling fast operation speed and handling various languages with a single model. First, the conversation analysis 508 uses graphic-to-phoneme conversion. The Graphic2Phoneme (G2P) function converts natural language into phonemes using rule-based processing for fast performance before performing phoneme sequence analysis. Using the phoneme sequences as input, Prosody features are predicted. For example, Prosody Features may include pitch, duration, and energy. The Prosody features are used to determine an Urgent Score using the following:

$$Urgent Score = ( weight 1 ) * pitch + ( weight 2 ) * duration + ( weight 3 ) * energy$$

A higher Urgent Score indicates a more urgent message and analysis priority is increased. A Prosody function allows for language-agnostic operation in a multilingual environment. The output feature is lightweight, enabling fast processing on mobile devices. The G2P function may process 1˜5 ms on-device, while the Prosody function also uses a lightweight model to process 5 ms or less on-device (such as on a 5-word basis).

The conversation analysis 508 offers several advantages improves efficiency utilizing separate functions for commonly used file formats can result in faster conversion times. Further, employing publicly available functions and APIs can reduce development costs and improve overall efficiency. Additionally, the multi-source LLM approach enables accurate analysis of complex file types by considering multiple aspects of the content.

The conversation analysis 508 includes an input and an output. The input may include attached files of various formats, including images, audio files, documents, maps, videos, and web links. The output may include text format representing the attached file content. The conversation analysis 508 includes one or more functions dedicated to commonly used file formats and a multi-source LLM for complex file types. Additionally, the conversation analysis 508 includes API Integration to integrate with publicly available APIs to reduce development costs and improve efficiency.

The conversation analysis 508 includes is designed to operate in the background, allowing for continuous analysis of attached files without disrupting user experience. For example, the system checks if the file format requires separate function utilization or multi-source LLM analysis. If necessary, the corresponding function is utilized to analyze and convert the file content into text format. The resulting text output is stored in a temporary cache for future reference. This process repeats every time a new attached file is input, ensuring continuous background processing without impacting user performance.

The response action generation 510 is designed to provide early conversation support for users based on personalized prompts. This function aims to offer context understanding, language misuse prevention, provision of specialized knowledge, photo transmission prevention, and message transmission time recommendation features.

The response action generation 510 may analyze the entire flow of a conversation, providing suggestions for user responses in one-on-one or small group (N users) conversations. The system utilizes message data stored on the user's device to generate customized prompts tailored to each individual. This enables context understanding, language misuse prevention, provision of specialized knowledge, photo transmission prevention, and message transmission time recommendation features. The method utilizes recent conversation records and personal prompts to provide early conversation support for users. By analyzing message data stored on the user's device, the system generates customized prompts tailored to each individual. This configuration is ideal for basic communication scenarios. Develop an efficient approach to managing large conversation channels 414 with more than N users. This configuration is suitable for handling complex conversations involving numerous participants. The response action generation 510 may implement a verification function to monitor messages sent by other users, particularly useful for administrators or group leaders managing the conversation flow. The rules and guidelines may be defined as desired for conversation analysis and response generation. Users also have the flexibility to customize their experience based on personal preferences.

Additionally, or alternatively, the response action generation 510 may manage large conversation channels 414 with over N users. When there are too many users in a conversation channel 414, applying individualization to all users is not efficient. Therefore, this system proposes an efficient method for managing large conversation channels 414 or social services.

In a social service channel where there are many users, roles are usually assigned, and users behave accordingly. For example, in a company setting, a team leader leads the discussion and provides information, while participants provide feedback and engage in conversations. Similarly, in a private space, operators, sub-operators, and participants work together to manage the conversation channel 414. Therefore, it is important to inform users of their turn to speak and the topic of conversation before sending messages, especially when the tone is casual or social.

The response action generation 510 may analyze the information provided by the social service channel to identify important users such as moderators and leaders. Additionally, infer roles based on the flow of conversations.

The response action generation 510 may the collect information about users from message flows and user profiles. If it is difficult to obtain information, request input from users. For example, in an internal messaging platform, a user's department and job title may be displayed, but this information may not be available in other social services. Therefore, users should provide direct input for the target they are concerned about.

When a user specifies a target using commands such as “@”, analyze the target's profile and previous messages. Our method can provide suggestions based on the analysis.

It is possible to efficiently manage large conversation channels 414 with over N users. This approach can improve the efficiency of conversation channels 414 and help users collaborate better and engage in conversations more effectively.

Additionally, or alternatively, the response action generation 510 may use a verification function for messages from others. The current system aims to prevent user errors and provide a more effective communication environment by verifying messages sent by others. When a user posts a message, the verification function is triggered if the receiving user has enabled this feature or requests analysis of the message. The function analyzes the profile and message history of the sending user to determine whether their message is relevant, respectful, and accurate in response to the original question.

If the analysis results indicate that the message requires attention from the recipient, a “Tip” or highlighting feature can be added to draw the recipient's attention. If the message contains rude conversation or offensive language, a warning sign can be displayed next to the message to alert the recipient and prevent further escalation.

The verification function for messages from others will analyze the profile of the sending user, including their communication style, tone, and reputation. The verification function will analyze message history between the sending user and the receiving user, including any previous conflicts or misunderstandings as well as the relevance and accuracy of the sending user's response to the original question.

The verification function will provide a score based on these factors, indicating whether the sending user's message is relevant (“Does the message directly address the original question?”), respectful (“Is the tone and language used respectful and considerate?”), and accurate (Does the message contain accurate information?”).

If the score indicates that the message requires attention or contains problematic elements, the verification function will take appropriate actions to alert the receiving user and prevent further communication issues.

The error detection 512 is designed to create responses for pre-emptive dialogue based on personalized prompts from the response action generation 510. The error detection 512 uses one or more LLMs to generate responses tailored to specific conversation contexts. The error detection 512 calls LLMs based on the integrated personalized and method-specific prompts, generating responses that are relevant to the pre-emptive dialogue context.

The error detection 512 can operate in either an on-demand mode or a pre-cached mode. In the on-demand mode, the function generates responses dynamically when a user interacts with the system. In the pre-cached mode, the function creates responses ahead of time and stores them for later use.

The error detection 512 can be deployed either on-device (i.e., on the user's device) or in the cloud, depending on the specific requirements of the service or application. The system suggests that either deployment option can be sufficient but notes that the choice of target LLM will depend on the expected performance.

The error detection 512 can operate in the background to pre-cache responses or wait for user input before generating responses. The decision as to which mode is used will ultimately depend on the service or application, taking into account factors such as response latency and processing overhead

For example, suppose a user initiates a conversation in real-time, requiring the system to generate responses quickly. If the error detection 512 is configured to operate solely in pre-cached mode, it may experience delays or performance bottlenecks due to the need to access pre-stored responses from remote servers (e.g., cloud-based storage). In contrast, on-device operation can provide faster response times and better overall performance but may require more processing power and memory resources.

To address these concerns, a hybrid approach that combines both on-demand and pre-cached modes of operation can be employed. The error detection 512 can generate responses dynamically in real-time (on-demand mode) while also caching responses for later use (pre-cached mode). This approach allows the system to balance response latency with processing overhead and memory requirements, providing a more seamless user experience.

The error detection 512 is designed to work seamlessly within various service or application frameworks, ensuring that users receive context-specific responses in real-time. By adapting to different deployment scenarios and performance constraints, this function can provide unparalleled support for pre-emptive dialogue functionality.

Although FIG. 5 illustrates a block diagram of an example prompt-based proactive conversation support system algorithm 500, various changes may be made to FIG. 5. For example, various components and functions in FIG. 5 may be combined, further subdivided, replicated, or rearranged according to particular needs. Also, one or more additional components and functions may be included if needed or desired.

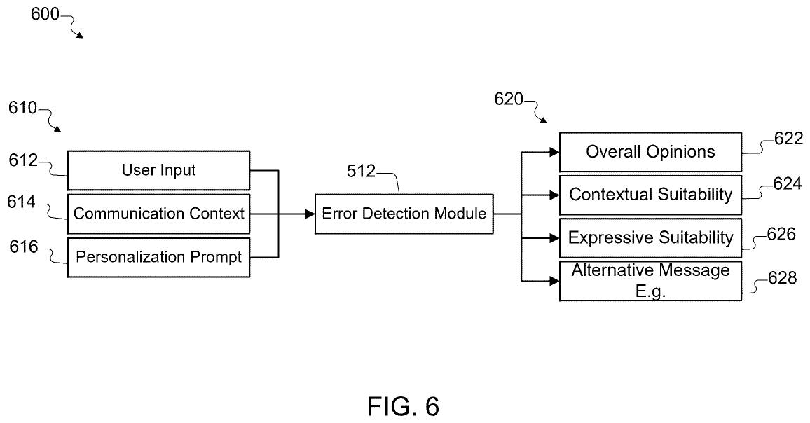

FIG. 6 illustrates a block diagram of an example error detection function of a prompt-based proactive conversation support system according to an embodiment of the present disclosure.

As shown in FIG. 6, the warning and suggestion 514 may receive one or more inputs 610, such as a user input 612, a communication context 614, and a personalized prompt 616, to produce one or more outputs 620, including overall opinions 622, a contextual suitability 624, an expressive suitability 626, and an alternative message examples 628. The warning and suggestion 514 provides functionality similar to that of the response action generation 510. However, its primary purpose is to perform Pre-Transmission Verification on user input prior to message transmission. For example, the warning and suggestion 514 verifies the accuracy and correctness of user input by analyzing the input. The warning and suggestion 514 assesses whether the user's input is relevant, coherent, and suitable for the current conversation context. It evaluates whether the input is aligned with the preceding conversation or topic. It examines the tone, language, and style used in the original conversation to determine if the new input is consistent and relevant. It suggests alternative messages based on communication context.

These perspectives are not mutually exclusive, and the warning and suggestion 514 can combine them to provide a comprehensive analysis of user input. The service or application utilizing this system can define the desired opinions and adjust the prompts accordingly.

While it may be challenging for the warning and suggestion 514 to cache or pre-generate responses like the response action generation 510, it can perform background verification when the user completes typing or reaches a certain time threshold. This approach enables the system to minimize perceived delays and provide a more seamless user experience.

By doing so, the warning and suggestion 514 can identify potential errors or inconsistencies in user input before transmission, ensuring that messages are accurate, relevant, and suitable for the conversation context.

Although FIG. 6 illustrates a block diagram of an example error detection function of a prompt-based proactive conversation support system, various changes may be made to FIG. 6. For example, various components and functions in FIG. 6 may be combined, further subdivided, replicated, or rearranged according to particular needs. Also, one or more additional components and functions may be included if needed or desired.

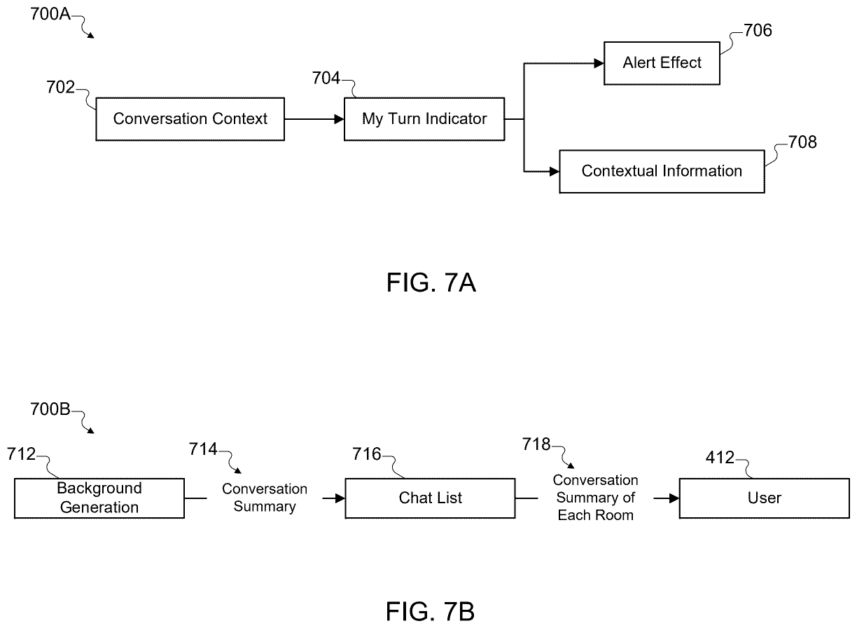

FIGS. 7A and 7B illustrate block diagrams of example pre-emptive dialogue functions 700A, 700B of a prompt-based proactive conversation support system according to an embodiment of the present disclosure.

The warning and suggestion 514 is responsible for displaying warnings and suggestions to users based on the output from the error detection 512 and response action generation 510, which utilize LLMs. While the application or service utilizing this system determines when and how to display these warnings and suggestions, there are more than one way to do so.

As shown in FIG. 7A, the pre-emptive dialogue function 700A includes an indicator 704 that receives conversation context 702 to produce either an alert effect 706 or contextual information 708. To address potential user frustration with pre-emptive dialogue 474, the pre-emptive dialogue function 700A allows users to set preferences for each conversation channel 414. For example, the pre-emptive dialogue 474 may be designed to display an indicator 704 based on the conversation context. If the value of indicator 704 is True, the function may provide an alert effect similar to being directly mentioned with the “at” symbol, along with contextual information.

Additionally, or alternatively, as shown in FIG. 7B, the pre-emptive dialogue function 700B includes background generation 712 that generates a conversation summary 714 that is provided to a chat list 716. The chat list 716, using the conversation summary 714, may be used to generate conversation channel summary 718 and provided to a user via the messaging interface 412. The pre-emptive dialogue function 700B may also provide a conversation summary that users may view from the chat list. This allows users to quickly grasp the conversation without having to enter the conversation channel 414, reducing unnecessary costs, and improving their overall experience.

Although FIGS. 7A and 7B illustrate block diagrams of example pre-emptive dialogue functions 700a, 700B of a prompt-based proactive conversation support system, various changes may be made to FIGS. 7A and 7B. For example, various components and functions in FIGS. 7A and 7B may be combined, further subdivided, replicated, or rearranged according to particular needs. Also, one or more additional components and functions may be included if needed or desired.

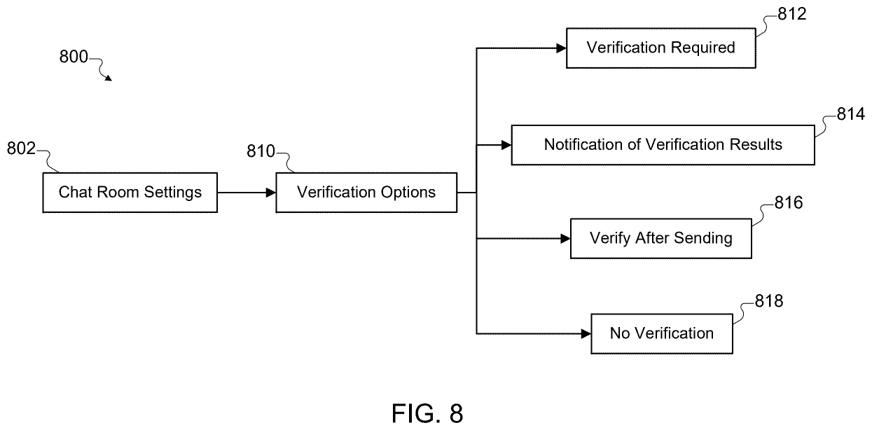

FIG. 8 illustrates a block diagram of an example pre-transmission verification function of a prompt-based proactive conversation support system according to an embodiment of the present disclosure.

As shown in FIG. 8, the 800 includes channel settings 802 that may be communicatively coupled to one or more verification options 810. The one or more verification options 810 may include, for example, a verification required setting 812, a result notification setting 814, a verification after sending setting 816, and a no verification setting 818. To address potential user frustration with the verification message generation 478, the 800 allows users to set preferences for each conversation channel 414. For example, the verification required setting 812 requires verification before sending messages in that conversation channel 414. The result notification setting 814 will notify users about the verification results after sending a message. The verification after sending setting 816 will verify messages after they have been sent, without interrupting a workflow of the user. Additionally, the no verification setting 818 will not verify messages in that conversation channel 414.

Although FIG. 8 illustrates a block diagram of an example pre-transmission verification function of a prompt-based proactive conversation support system, various changes may be made to FIG. 8. For example, various components and functions in FIG. 8 may be combined, further subdivided, replicated, or rearranged according to particular needs. Also, one or more additional components and functions may be included if needed or desired.

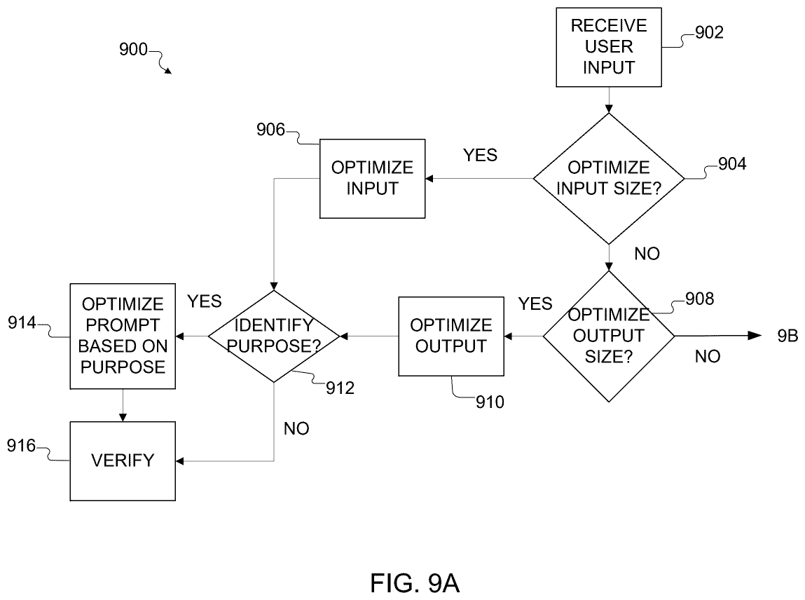

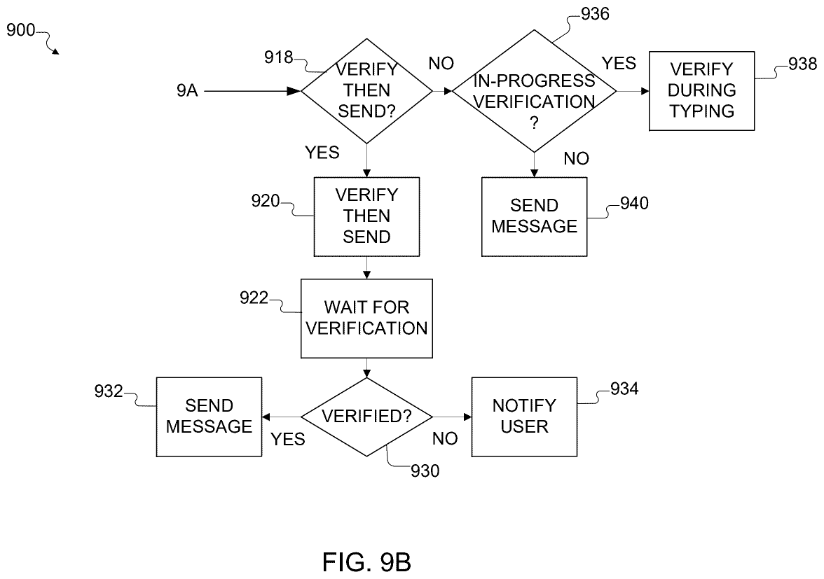

FIGS. 9A and 9B illustrate a block diagram of an example speed optimization function speed optimization function 900 for pre-transmission verification of a prompt-based proactive conversation support system according to an embodiment of the present disclosure.

In particular, the speed optimization function 900 may be implemented as part of the warning and suggestion 514 as the pre-transmission verification process may cause significant latency, potentially degrading user experience. The speed optimization function 900 allows reduction in latency to optimize performance.

As shown in FIG. 9A, the speed optimization function 900 begins with receiving user input (operation 902). Using the entire chat history as input increases the inference time and requires a large context window, making it difficult to use on-device models. Instead, the speed optimization function 900 uses the text generated during pre-emptive dialogue 474 as the basis for communication context. The user input may also include the additional input 418. The input may require size optimization (operation 904). If so, the input size is optimized (operation 906). If not, the output may be evaluated for size optimization (operation 908) and subsequently optimized for size (operation 910). The optimized input or the optimized output may then be evaluated for purpose identification (operation 912) where the input or output purpose is included in a verification process. If purpose identification is requested or otherwise activated, the input is optimized based on the identified purpose (operation 914). In either case, the input is then used to perform a verification process (operation 916).

If the input size is not to be optimized and the output size is not to be optimized (such as indicating NO at operations 904 and 908), the speed optimization function 900 proceeds to evaluate whether verification is to occur before sending a message (operation 918) as shown in FIG. 9B. If verification is required, the speed optimization function 900 will perform a verify-then-send process (operation 920), wait for verification (operation 922), then evaluate the result of the verification process (930). If the verification is successful, the message is sent (operation 932). Otherwise, the user is notified of the failed verification (operation 934). Provide “Verify Then Send” Feature. Users often wonder if their message was sent correctly. This feature allows users to send messages normally but waits for verification before actually sending them. If verified successfully, the message is sent; otherwise, users are notified and prompted to edit.

If a verify-then-send process is not required (NO indicated at operation 918), the speed optimization function 900 will evaluate whether an in-progress verification setting is required (operation 936). If so, verification will occur while a user is inputting a message, such as while the user is typing, and will continuously verify until the message is sent (operation 938). Instead of verifying messages only when the send button is clicked, this method verifies during typing pauses or word completions to provide real-time feedback. If no in-progress verification is required, then the message will be sent without verification (operation 940).

Verification may use shorter output tokens reduce LLM inference time. The speed optimization function 900 simplifies the output format (such as “Not suitable with context” or “Suitable”) to optimize processing by prompt tuning. The speed optimization function 900 optimizes input prompts based on the conversation channel 414 or target audience to reduce inference time. For example, in a conversation channel 414 without profanity, for example, the verification process may use a prompt like “Generate ‘Valid’ if input is clean, else ‘Invalid’”, where the verification may include comparing the input to a database of unauthorized words then produce the prompt based on the presence of unauthorized words in the input.

Although FIGS. 9A and 9B illustrate a block diagram of an example speed optimization function for pre-transmission verification of a prompt-based proactive conversation support system, various changes may be made to FIGS. 9A and 9B. For example, various components and functions in FIGS. 9A and 9B may be combined, further subdivided, replicated, or rearranged according to particular needs. Also, one or more additional components and functions may be included if needed or desired.

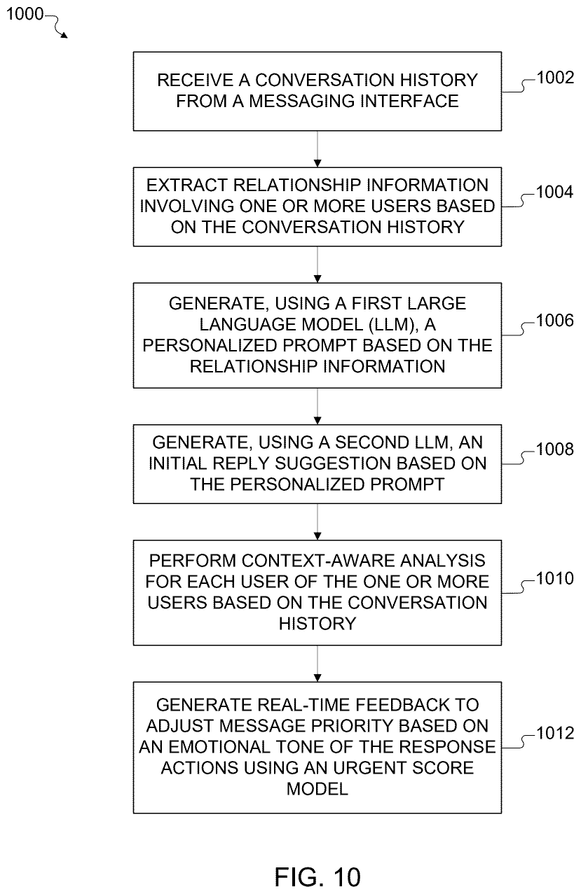

The prompt-based proactive conversation support system architecture 400 may be used by a processor executing a method for a prompt-based proactive conversation support in response to receiving user input on an electronic device. For example, the prompt-based proactive conversation support system architecture 400 may execute a method as shown in FIG. 10.

FIG. 10 illustrates a block diagram of an example method 1000 for a prompt-based proactive conversation support according to an embodiment of the present disclosure. For ease of explanation, the method 1000 is described as involving the use of the electronic device 101 in the network configuration 100 of FIG. 1 and the prompt-based proactive conversation support system device architecture 300 of FIG. 3. However, the method 1000 may be used with any other suitable electronic device (such as the server 106) or a combination of devices (such as the electronic device 101 and the server 106) and in any other suitable system(s).

As shown in FIG. 10, a conversation history from a messaging interface is received in step 1002. For example, the messaging interface 412 may provide a conversation history 416 from a conversation channel 414 to the second LLM 470.

Relationship information is extracted involving one or more users based on the conversation history in step 1004. For example, the first LLM 460 may extract relationship information 458 from conversation data 456 aggregated during data collection 454. The first LLM 460 may extract features from the conversation data 456 correlated to relationships between one or more users in the conversation channel 414.

A personalized prompt is generated, using a first large language model (LLM), based on the relationship information in step 1006. For example, the first LLM may be configured to anticipate user interaction based on contextual patterns in the conversation history, pre-process multimodal chat data into hierarchical structured representations, and generate partial structured data based on the anticipated user interaction and the hierarchical structured representations. To generate the personalized prompt, the first LLM is configured to predict user interactions based on real-time chat context and historical interaction patterns using a dynamic pre-fetching model. The dynamic pre-fetching model includes a reinforcement learning model configured to adjust a pre-fetching policy of the dynamic pre-fetching model based on an uncertainty score of a current response trajectory of the response actions from the second LLM.

An initial response action is generated, using a second LLM, based on the personalized prompt in step 1008. For example, the second LLM receives the personalized prompt from the first LLM and uses the personalized prompt and the received conversation history to generate a response action, such as a pre-emptive dialogue 474. Additionally, the second LLM may be configured to incrementally generate response actions based on the partial structured data received from the first LLM and adapt generated response actions using additional structured data. To generate the initial response action, the first LLM may asynchronously transmit partial pre-processed data to the second LLM using a streaming interface and generate the initial reply suggestion using a lightweight language model (LM) of a latency-aware fallback model in response to detecting of a processing delay of the second LLM. The latency-aware fallback model is configured to combine a placeholder suggestion with the response actions from the second LLM using an attention-weighted semantic alignment model.

Context-aware analysis is performed, using an adaptive context-aware response timing model coupled to the first LLM, for each user of the one or more users based on the conversation history in step 1010. For example, the context-aware analysis may include analysis of conversational flow, language nuances, and user intent.

Real-time feedback is generated, using a real-time feedback model, to adjust message priority based on an emotional tone of the response actions using an urgent score model in step 1012. For example, the conversation analysis 508 employs linguistic analysis to regulate priority orders while enabling fast operation speed. The conversation analysis 508 may use a G2P function and Prosody features related to phoneme pitch, duration, and energy to generate an Urgent Score. The Urgent Score is then used to adjust message priority.

Although FIG. 10 illustrates one method 1000 for an example method for a prompt-based proactive conversation support, various changes may be made to FIG. 10. For example, while shown as a series of steps, various steps in FIG. 10 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An electronic device comprising:
at least one processing device configured to:
receive a conversation history from a messaging interface;
extract relationship information involving one or more users based on the conversation history;
generate, using a first large language model (LLM), a personalized prompt based on the relationship information, wherein, to generate the personalized prompt, the at least one processing device is configured to predict user interactions based on real-time chat context and historical interaction patterns using a dynamic pre-fetching model; and
generate, using a second LLM, an initial reply suggestion based on the personalized prompt, wherein, to generate the initial reply suggestion, the at least one processing device is configured to:
asynchronously transmit partial pre-processed data from the first LLM to the second LLM using a streaming interface; and
generate the initial reply suggestion using a lightweight language model (LM) of a latency-aware fallback model in response to detecting of a processing delay of the second LLM.

2. The electronic device of claim 1, wherein:
the first LLM is configured to:
anticipate user interaction based on contextual patterns in the conversation history;
pre-process multimodal chat data into hierarchical structured representations; and
generate partial structured data based on the anticipated user interaction and the hierarchical structured representations; and
the second LLM is configured to:
incrementally generate response actions based on the partial structured data received from the first LLM; and
adapt generated response actions using additional structured data.

3. The electronic device of claim 2, wherein the at least one processing device is further configured to:
generate, using a real-time feedback model, real-time feedback to adjust message priority based on an emotional tone of the response actions using an urgent score model.

4. The electronic device of claim 2, wherein the dynamic pre-fetching model comprises a reinforcement learning model configured to adjust a pre-fetching policy of the dynamic pre-fetching model based on an uncertainty score of a current response trajectory of the response actions from the second LLM.

5. The electronic device of claim 2, wherein the latency-aware fallback model is configured to combine a placeholder suggestion with the response actions from the second LLM using an attention-weighted semantic alignment model.

6. The electronic device of claim 2, wherein the at least one processing device is further configured to:
perform context-aware analysis, using an adaptive context-aware response timing model coupled to the first LLM, for each user of the one or more users based on the conversation history.

7. The electronic device of claim 6, wherein the context-aware analysis includes analysis of conversational flow, language nuances, and user intent.

8. A method, comprising:
receiving a conversation history from a messaging interface;
extracting relationship information involving one or more users based on the conversation history;
generating, using a first large language model (LLM), a personalized prompt based on the relationship information, wherein, to generate the personalized prompt, the first LLM is configured to predict user interactions based on real-time chat context and historical interaction patterns using a dynamic pre-fetching model; and
generating, using a second LLM, an initial reply suggestion based on the personalized prompt, wherein generating the initial reply suggestion comprises:
asynchronously transmitting partial pre-processed data from the first LLM to the second LLM using a streaming interface; and
generating the initial reply suggestion using a lightweight language model (LM) of a latency-aware fallback model in response to detecting of a processing delay of the second LLM.

9. The method of claim 8, wherein:
the first LLM is configured to:
anticipate user interaction based on contextual patterns in the conversation history;
pre-process multimodal chat data into hierarchical structured representations; and
generate partial structured data based on the anticipated user interaction and the hierarchical structured representations; and
the second LLM is configured to:
incrementally generate response actions based on the partial structured data received from the first LLM; and
adapt generated response actions using additional structured data.

10. The method of claim 9, further comprising:
generating, using a real-time feedback model, real-time feedback to adjust message priority based on an emotional tone of the response actions using an urgent score model.

11. The method of claim 9, wherein the dynamic pre-fetching model comprises a reinforcement learning model configured to adjust a pre-fetching policy of the dynamic pre-fetching model based on an uncertainty score of a current response trajectory of the response actions from the second LLM.

12. The method of claim 9, wherein the latency-aware fallback model is configured to combine a placeholder suggestion with the response actions from the second LLM using an attention-weighted semantic alignment model.

13. The method of claim 9, further comprising:
performing context-aware analysis, using an adaptive context-aware response timing model coupled to the first LLM, for each user of the one or more users based on the conversation history.

14. The method of claim 13, wherein the context-aware analysis includes analysis of conversational flow, language nuances, and user intent.

15. A non-transitory computer-readable medium comprising program code, that when executed by at least one processor of an electronic device, causes the electronic device to:
receive a conversation history from a messaging interface;
extract relationship information involving one or more users based on the conversation history;
generate, using a first large language model (LLM), a personalized prompt based on the relationship information, wherein, to generate the personalized prompt, the first LLM is configured to predict user interactions based on real-time chat context and historical interaction patterns using a dynamic pre-fetching model; and
generate, using a second LLM, an initial reply suggestion based on the personalized prompt, wherein, to generate the initial reply suggestion, the second LLM is configured to:
asynchronously transmit partial pre-processed data from the first LLM to the second LLM using a streaming interface; and
generate the initial reply suggestion using a lightweight language model (LM) of a latency-aware fallback model in response to detecting of a processing delay of the second LLM.

16. The non-transitory computer-readable medium of claim 15, wherein:
the first LLM is configured to:
anticipate user interaction based on contextual patterns in the conversation history;
pre-process multimodal chat data into hierarchical structured representations; and
generate partial structured data based on the anticipated user interaction and the hierarchical structured representations; and
the second LLM is configured to:
incrementally generate response actions based on the partial structured data received from the first LLM; and
adapt generated response actions using additional structured data.

17. The non-transitory computer-readable medium of claim 16, further comprising program code, that when executed by the at least one processor, causes the electronic device to:
generate, using a real-time feedback model, real-time feedback to adjust message priority based on an emotional tone of the response actions using an urgent score model.

18. The non-transitory computer-readable medium of claim 16, wherein the dynamic pre-fetching model comprises a reinforcement learning model configured to adjust a pre-fetching policy of the dynamic pre-fetching model based on an uncertainty score of a current response trajectory of the response actions from the second LLM.

19. The non-transitory computer-readable medium of claim 16, wherein the latency-aware fallback model is configured to combine a placeholder suggestion with the response actions from the second LLM using an attention-weighted semantic alignment model.

20. The non-transitory computer-readable medium of claim 16, further comprising program code, that when executed by the at least one processor, causes the electronic device to:
perform context-aware analysis, using an adaptive context-aware response timing model coupled to the first LLM, for each user of the one or more users based on the conversation history, wherein the context-aware analysis includes analysis of conversational flow, language nuances, and user intent.
